(19) United States
(12) Patent Application Publication
(10) Pub. No.: US 2011/0236167 A1
(43) Pub. Date: Sep. 29, 2011

(54) TRUCK WITH EXTERNAL ARM ASSEMBLY CONTROLS

(75) Inventor: BRIAN BORGATELLO, Goleta, CA (US)

(73) Assignee: Marborg Industries, Inc.

(21) Appl. No.: 12/889,182

(22) Filed: Sep. 23, 2010

Related U.S. Application Data
(60) Provisional application No. 61/245,224, filed on Sep. 23, 2009.

(51) Int. Cl. B65F 3/04

(52) U.S. Cl. 414/408

(57) ABSTRACT

Improved trash trucks are disclosed having arm assembly controls arranged to provide improved vision of the front of a trash truck when operating the forks through the trash container lifting, dumping and lowering operations. The arm assembly controls can be arranged in many different locations on the truck to provide this improved vision, and in one embodiment the controls are located on the driver's door a sufficient distance back from the front of the truck to allow for safe operation by the truck operator, but far enough forward to allow the truck operator to see the area to the front of the trash truck.

This application claims the benefit of U.S. Provisional Application Ser. No. 61/245,224, to Borgatello, filed on Sep. 23, 2009.

### BACKGROUND OF THE INVENTION

1. Field of the Invention

This invention relates to trash trucks, and in particular to trash trucks having a novel outside control mechanism arrangement that gives the user improved vision to the front of the truck while lifting and lowering loads.

2. Description of the Related Art

Conventional trash trucks have been developed that allow for the emptying of trash containers using an arm assembly mechanism that lifts the trash container at the front of the truck and empties it in the bed of the truck. This mechanism typically comprises an arm assembly pivotally attached to truck chassis at some point rearward of the truck cab. Hydraulic cylinders and valve mechanisms provide force and control means to swing the arm assembly from a lowered loading position where the forks engage the trash container, to a raised dumping position where trash from the container is dumped in the bed of the truck. Front forks are pivotally mounted at the front of the arm assembly. Hydraulic cylinders and valve apparatus provide force and control means, independent of the arm assembly controls, so that the forks may be rotated and controlled independently of the fork frame.

Conventional trucks also comprise arm assembly controls that allow for the user to operate the arm assembly through the lifting, dumping and lowering steps for the trash container. In some of these trucks, multiple controls can be provided that allow for operation of the arm assembly from within the interior of the truck cab, such as from the driver's seat, or from outside the truck. FIG. 1-4 show a conventional trash truck 10 with one of its arm assembly controls 12 located outside and behind the cab 14 of the truck 10. In these types of trucks the controls are mounted to the wheel well 16 above the front left wheel 18. The truck 10 comprises an arm and fork assembly (not shown) that lift trash containers located at the front of the truck 10. These arm and fork assemblies are most often used for lifting rectangular dumpsters with the channels on either side. The fork slides into the channel and the dumpster is lifted by the arm assembly, dumping the contents of the dumpster into the bed of the truck.

As best shown in FIG. 4 in conventional trucks 10 the area just to the front of the cab 14 is blocked by the cab when operating the arm assembly controls 12 from the location behind the cab 14. This can present a danger to pedestrians and vehicles that pass in front of the truck 10 during the lifting, dumping and lowering operations. The truck operator's vision can be blocked by the cab 14 such that the operator may be unaware that the pedestrian or vehicle is now in front of the truck 10. Injury or death can result from the lowering of the trash container on this person or vehicle, or by falling debris during the dumping and lowering operation.

### SUMMARY OF THE INVENTION

Embodiments of the invention provide improved trash trucks having arm assembly controls arranged to provide improved vision of the front of a trash truck when operating the forks through the trash container lifting, dumping and lowering operations. The arm assembly controls can be arranged in many different locations on the truck to provide this improved vision, and in one embodiment the controls are located on the driver's door a sufficient distance back from the front of the truck to allow for safe operation by the truck operator, but far enough forward to allow the truck operator to see the area to the front of the trash truck.

One embodiment of a trash truck according to the present invention comprises an arm assembly for lifting trash receptacles at the front of the truck. An arm assembly system is included for causing the arm assembly to lift the trash receptacle. The arm assembly system comprises a first arm assembly controls operable from outside the truck to control the arm assembly system, with the arm assembly controls arranged forward of the truck's front wheel wells.

Another embodiment of a trash truck according to the present invention comprises an arm assembly for lifting trash receptacles at the front of the truck. An actuation mechanism is included for causing the arm mechanism to lift the trash receptacle. The actuation mechanism further comprises a first arm assembly controls operable from outside the truck, with the first arm assembly controls mounted to the truck in a location that provides greater user visibility of the area in front of the truck compared to the same truck having a first arm assembly controls mounted adjacent the truck's front wheel well.

Another embodiment of a truck according to the present invention comprises a lifting mechanism for lifting objects outside the truck. A lifting system is included for causing the lifting mechanism to lift the objects, with the lifting system comprising a first lifting controls operable from outside the truck. The lifting controls are arranged on the truck such that the lifting system can be operated while still allowing for viewing of substantially all the area around the object to be lifted.

These and other aspects and advantages of the invention will become apparent from the following detailed description and the accompanying drawings which illustrate by way of example the features of the invention.

### BRIEF DESCRIPTION OF THE DRAWINGS

FIG. 1 shows a conventional trash truck with arm assembly controls located behind the truck cab;

FIG. 2 shows the truck in FIG. 1 from in front of the cab;

FIG. 3 shows the truck in FIG. 1 also from the front of the cab;

FIG. 4 shows the truck of FIG. 1, from behind the cab;

FIG. 5 shows the driver door at an initial point in the installation of a fork control box according to one embodiment of the present invention;

FIG. 6 shows the outside of the door with a central hole for mounting the control box;

FIG. 7 is the inside of the door shown in FIG. 6;

FIG. 8 is a perspective view of one embodiment of a control box according to the present invention;

FIG. 9 is another perspective view of the control box shown in FIG. 8;

FIG. 10 shows one embodiment of a lever control mechanism according to the present invention;

FIG. 11 is another view of the inside of the driver door with a support bracket and control lines passing through;

FIG. 12 shows one embodiment of the arm assembly controls mounted to the driver door according to the present invention; and

FIG. 13 is a schematic of the door mounted fork control relocation.

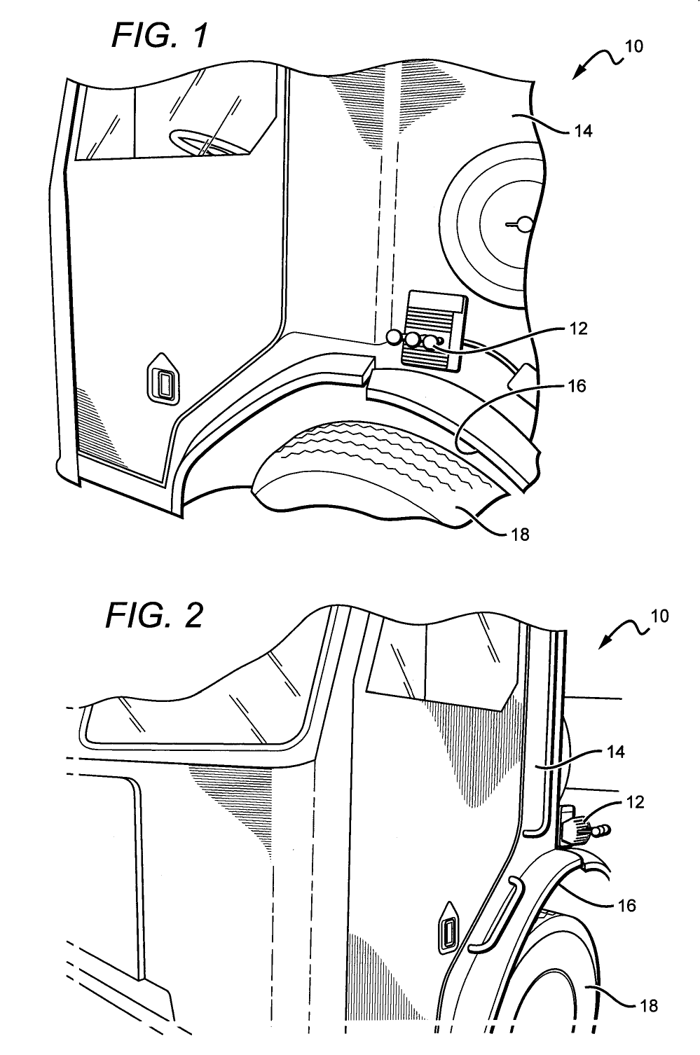

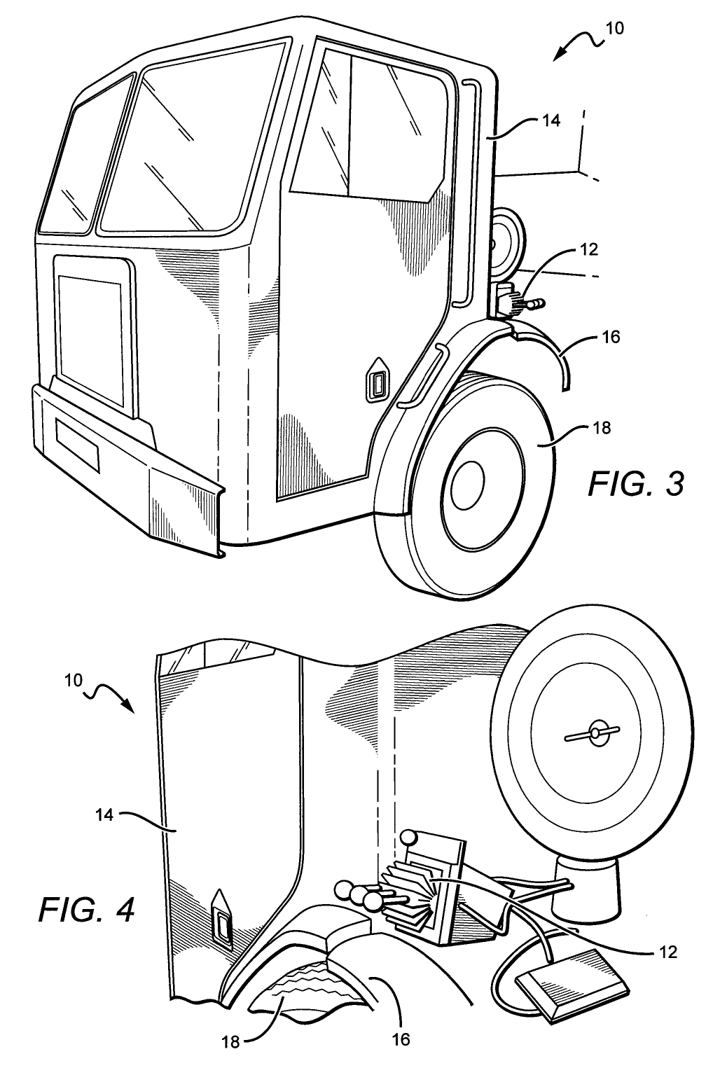

### DETAILED DESCRIPTION OF THE INVENTION

Improved trash trucks are disclosed having arm assembly controls that allow for safer operation of the trash truck. Some embodiments of the present invention have the arm assembly controls located in a position where the operator can safely operate the arm assembly and forks while providing for improved vision of the area in front of the truck. That is, the present invention is directed to improved control systems and mechanisms mounted near the front of the truck to provide for safer lifting, dumping and lowering of trash containers. In some embodiments, the arm assembly controls can be located forward of the truck's front wheel wells, but back far enough from the front of the truck to minimize the risk of injury to the user.

The present invention is described herein with reference to certain embodiments, but it is understood that the invention can be embodied in many different forms and should not be construed as limited to the embodiments set forth herein. In particular, the present invention is described below with regard to certain fork control locations and arrangements, but it is understood that the present invention can be arranged in many different ways. The components can have different shapes and sizes beyond those shown, and the controls can have different features.

It is also understood that when an element is referred to as being “on” another element, it can be directly on the other element or intervening elements may also be present. Furthermore, relative terms such as “inner”, “outer”, “upper”, “above”, “lower”, “beneath”, and “below”, and similar terms, may be used herein to describe a relationship of one element to another. It is understood that these terms are intended to encompass different orientations in addition to the orientation depicted in the figures.

Although the terms first, second, etc. may be used herein to describe various elements, these elements, components, and/or sections should not be limited by these terms. These terms are only used to distinguish one element from another. Thus, a first element discussed below could be termed a second element without departing from the teachings of the present invention. It is understood that actual systems embodying the invention can be arranged in many different ways with many more features and elements beyond what is shown in the figures.

Different embodiments of the present invention can be provided in new trucks during the manufacturing process or can be realized through the retrofit of existing trucks. The description below is directed to the retrofit of an existing truck with conventional arm assembly controls to provide improved and safer truck operation. It understood that similar arrangements could be provided in new trucks.

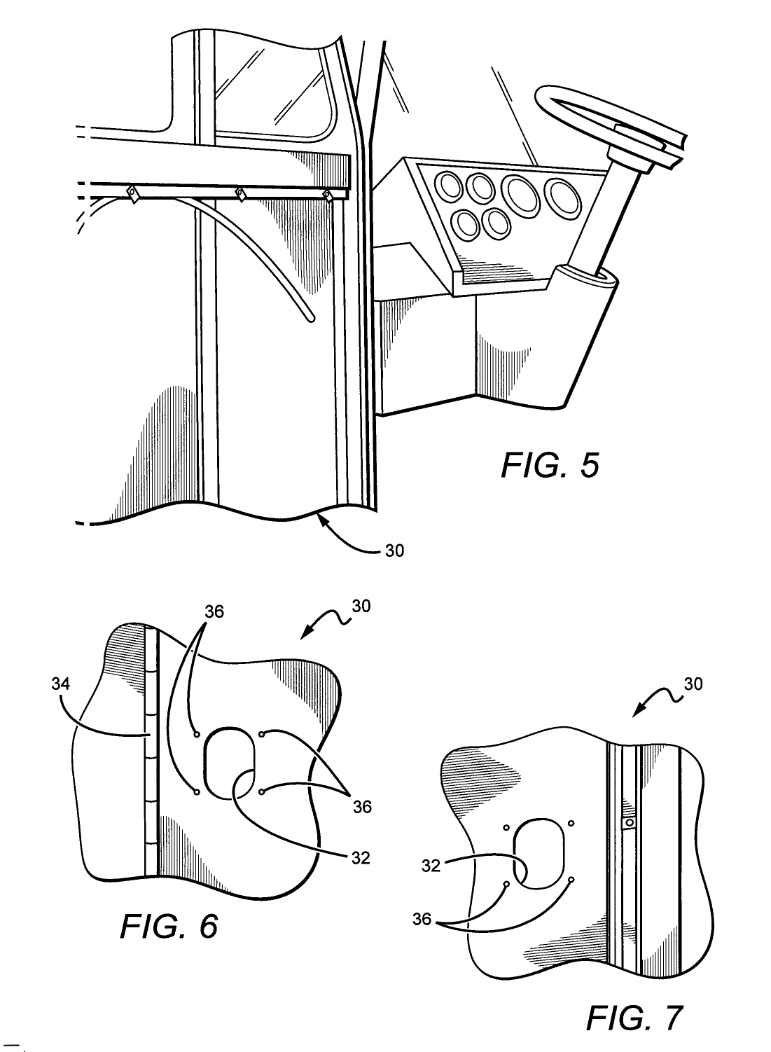

Referring now to FIG. 5, a truck retrofit process can begin by first removing the inside panel of the driver side door 30 to reveal the location where the improved arm assembly controls can be mounted. The inside panel can be saved and remounted to the door 30 once the arm assembly controls are mounted in place. This process can be accomplished using known methods and tools.

Referring now to FIGS. 6 and 7, a central hole 32 is formed in the driver side door 30 in the location for the arm assembly controls. The location for the central hole can vary, but is located so that when the operating controls are mounted over the central hole 32, the user can see a greater portion of the area to the front of the truck while operating the controls to lift and lower the trash container. In some embodiments, the user will be able to see substantially all the area in front of the truck.

In this embodiment, the central hole 32 is within a few inches of the hinges 34 of the driver door 30. The central hole 32 can be formed using many different known metal cutting techniques, and is sized to allow for the passage of control lines, such as hydraulic, compressed air, or electrical control lines. Four box mounting holes 36 are also included around the central hole 32 for mounting a control box (shown below) that houses the arm assembly controls. The mounting holes 36 align with mounting holes in the control box so the mounting screws or bolts can mount the box to the door, over the central opening.

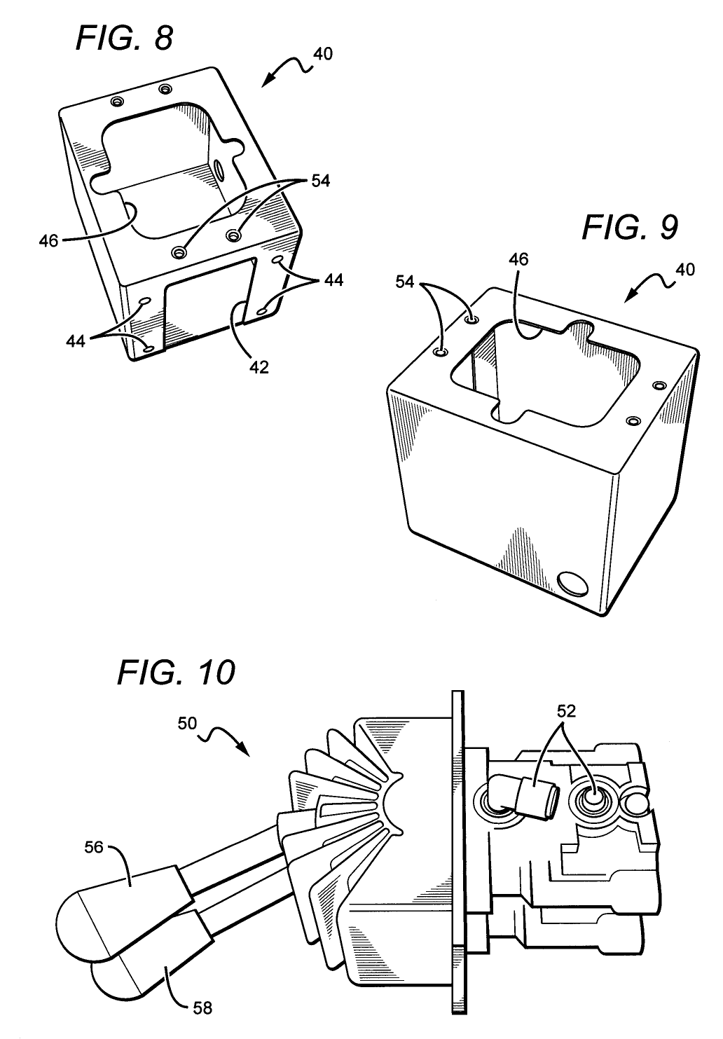

FIGS. 8 and 9 show one embodiment of a control box 40 according to the present invention having a generally rectangular shape, although it is understood that the box can be many different shapes. It is also understood that the arm assembly controls can be mounted in many different ways beyond a control box. That is, they can be mounted directly to the side door using any type of mounting mechanism, including but not limited to brackets, trays, screws, etc. The box 40 has a side opening 42 to allow control lines to pass through the central door hole 32 into the control box 40. Four box mounting holes 44 are included around the side opening 42 that align with the door mounting holes 36 for mounting the box over the door's central hole as described above.

The control box 40 also has a top opening 46 sized to accept a control lever mechanism that the operator manipulates to control the actions of an arm assembly and fords. FIG. 10 shows one embodiment of an arm assembly control mechanism 50 that can be mounted to the top opening of the box. The control mechanism 50 has a plurality of control line connection points 52 for connecting to the control lines that enter the box 40 (shown in FIGS. 8 and 9) through the door central hole 32 (shown in FIGS. 7 and 8). Referring again to FIGS. 8 and 9, the top opening 46 has four top mounting holes 54 that align with holes on the control lever mechanism 50 for mounting the control lever mechanism 50 to the box 40. In the embodiment shown, the control lever mechanism 50 comprises first and second levers 56, 58, but it is understood that more than two levers can be used and other types of control mechanisms can also be used.

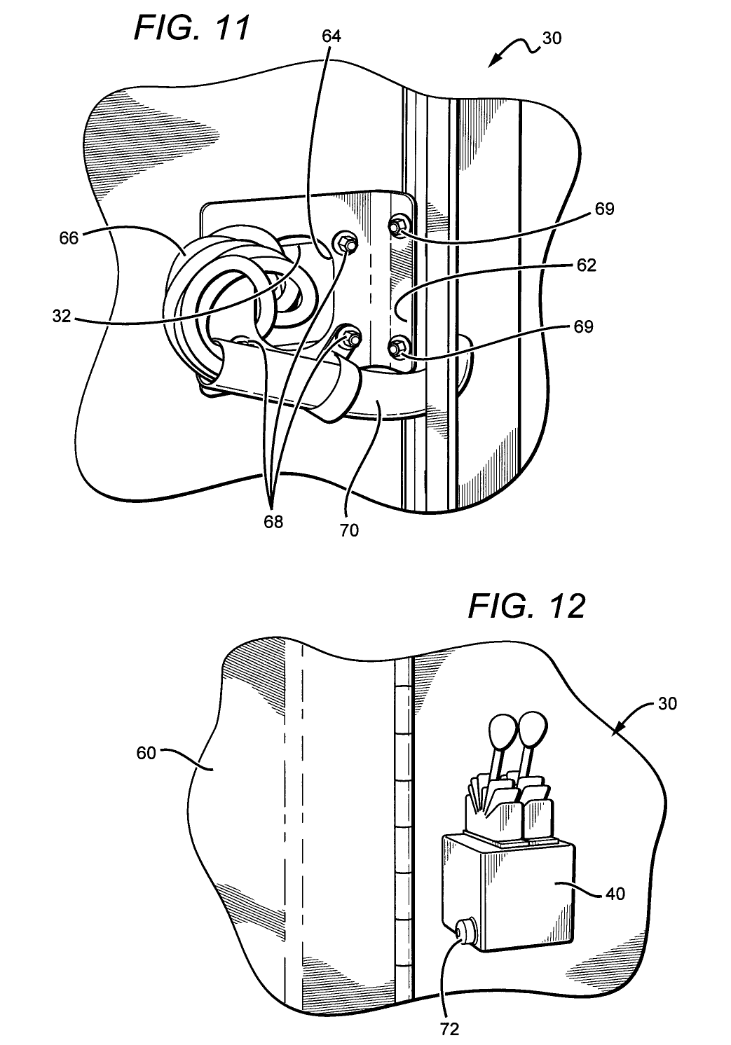

FIG. 11 shows the inside of the driver side door 30 for one embodiment of an arm assembly control location in a truck according to the present invention after the control box (not shown) has been mounted to the outside of the door 30. A support bracket 62 can be included on the inside of the door 30 to provide support to control box mounted to the outside of the door. The bracket 62 has a bracket opening 64 that aligns with the central hole 32 in the door 30 so that wires/cables 66 can pass through the bracket 62, through the central hole 32, and into the control box 40. Four mounting bolts 68 are shown that pass from the control box 40, through the door mounting holes 36 surrounding the central hole 32, and into aligned bracket holes. The bracket 62 is also mounted to the door frame by frame bolts 70 to provide further structural support. The bracket 62 can be made of many different known rigid materials, such as a metal, and can be fabricated using many known techniques.

The wires/cables 66 can comprise arm assembly and fork control lines that can originate from many different locations in the truck, and in one embodiment the wires/cables 66 tie into existing control lines coupled to the interior fork control mechanism. Different mechanisms can be used when tying into these existing lines, such as through the check valves located inside the truck. The control lines then pass through central hole 32 and the bracket hole 64, and into the control box 40 (shown in FIGS. 8 and 9) wherein they connect to the control mechanism 50 (shown in FIG. 10). A protective hose, sheath or conduit 70 can be included that also runs up to or through the central hole 32 and bracket hole 64, and at least partially into the control box 40. The conduit 70 helps prevent damage to the control lines from truck vibration or through the opening and closing of the door.

FIG. 12 shows the control box 50 mounted to the driver door 30, with the control lever mechanism 50 mounted in place in the control box' upper opening. The two lever arrangement for the control mechanism helps ensure that the operator keeps both hands on the controls during the lifting and lowering operations. This helps avoid injury to the operator. At the same time, the controls box 54 and control lever mechanism 50 are located close enough to the front of the truck 60 so that the operator can see the area in front of the truck while still keeping both hands on the controls.

The control box 40 can also have a side control button 72 that can be pressed during the lifting operation to increase the idle speed of the truck engine. This in turn can provide for increased lifting power for the fork frame.

As discussed above, this is only one of the many locations where the control box can be mounted according to the present invention, and the invention should in no way be limited to this particular location. By way of example only, the control box can be mounted at different locations on the door or can be mounted in areas around the door. The location of the control box should provide greater viewing of the front area of the truck when operating the arm and fork assembly, while still providing safe operation for the user. This arrangement helps to minimize damage and injury during the loading and unloading of trash receptacles. It is understood that the present invention can also include other devices to provide improved vision of the area at the front of the truck. Such devices can include mirrors or cameras that can provide the user an image of the area in front of the truck.

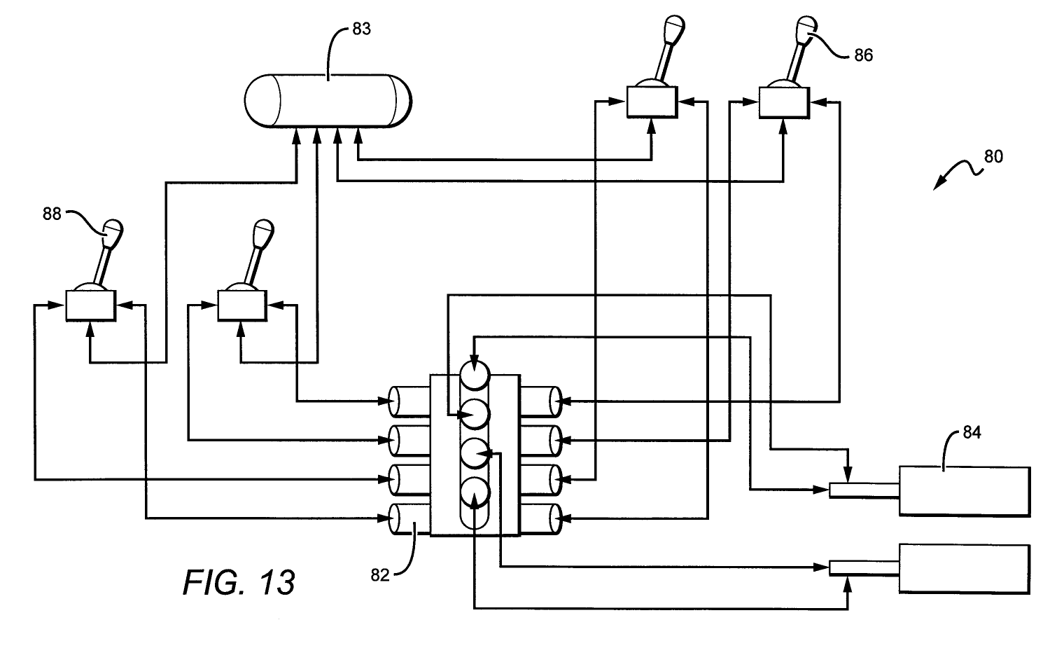

FIG. 13 shows schematic of one embodiment of the arm assembly control system 80 according to the present invention, with all elements of the system being found on the trucks according to the present invention. The system 80 comprises a standard check valve system 82 coupled to a valve body mechanism 84 using known interconnecting techniques. Standard inside cab controls 86 are provided, typically within the truck cab to allow the user to operate the arm assembly and forks from inside the cab. The inside cab controls 86 are coupled to the check valve system 82 and an air tank supply 83 using known devices and methods. Outside door controls (i.e. arm assembly controls) 88 are also provided as part of the system 80 and are mounted so that they can be operated from outside the cab. According to the present invention, the outside door controls 88 are located such that the user can see much of the area in front of the truck during operation of the arm assembly and forks. In the embodiment shown, the outside door controls can be mounted to the outside of the driver side door as discussed above, but it is understood that they can be in many other locations. Like the inside cab controls 86, the outside door controls 88 are coupled to the check valve system 82 and air tank supply 83 using much the same methods and devices used for the inside cab controls 86. As discussed above, any wires/cables used for this interconnect can pass through a hole formed in the door and can then be connected to the check valve device and air tank supply.

Many alterations and modifications may be made by those having ordinary skill in the art, given the benefit of the present disclosure, without departing from the spirit and scope of the inventive subject matter. Therefore, it must be understood that the illustrated embodiments have been set forth only for the purposes of example, and that it should not be taken as limiting the inventive subject matter as defined by the following claims. Therefore, the spirit and scope of the invention should not be limited to the versions described above.

I claim:

1. A trash truck, comprising:
an arm assembly for lifting trash receptacles at the front of the truck; and
an arm assembly system for causing said arm mechanism to lift said trash receptacle, said arm assembly system comprising a first arm assembly controls operable from outside said truck to control said arm assembly system, said arm assembly controls arranged forward of the truck's front wheel wells.

2. The truck of claim 1, wherein said first arm assembly controls is mounted to the driver side door.

3. The truck of claim 1, wherein said first arm assembly controls comprises a control lever mechanism.

4. The truck of claim 2, further comprising a check valve system, said first arm assembly controls coupled to said check valve system with wire/cables.

5. The truck of claim 4, wherein said wires/cables pass through said driver side door.

6. The truck of claim 1, wherein said first arm assembly controls comprises a control box.

7. The truck of claim 1, further comprising a second arm assembly controls located in the cab of said truck.

8. The truck of claim 1, further comprising a support bracket.

9. A trash truck, comprising:
an arm assembly for lifting trash receptacles at the front of the truck; and
an actuation mechanism for causing said arm mechanism to lift said trash receptacle, said actuation mechanism comprising a first arm assembly controls operable from outside said truck, said first arm assembly controls mounted to said truck in a location that provides greater user visibility of the area in front of the truck compared to the same truck having a first arm assembly controls mounted adjacent the truck's front wheel well.

10. The truck of claim 9, wherein said first arm assembly controls is mounted forward of the truck's front wheel well.

11. The truck of claim 9, wherein said first arm assembly controls is mounted to the driver side door.

12. A truck, comprising:
a lifting mechanism for lifting objects outside said truck; and
a lifting system for causing said lifting mechanism to lift said objects, said lifting system comprising a first lifting controls operable from outside said truck, said lifting controls arranged on the truck such that said lifting system can be operated while still allowing for viewing of substantially all the area around the object to be lifted.
